(19) United States
(12) Patent Application Publication
(10) Pub. No.: US 2025/0146832 A1
(43) Pub. Date: May 8, 2025

(54) MAP DISPLAYING SCHEMES USING MULTI-LAYER REPRESENTATION

(71) Applicant: TuSimple, Inc., SAN DIEGO, CA (US)

(72) Inventors: Ruimin ZENG, Seattle, WA (US); Anying ZHENG, San Diego, CA (US); Wan-Ting HUNG, Dublin, CA (US); Anpin WANG, San Diego, CA (US); Minhao JIANG, San Diego, CA (US); Hsin LU, San Diego, CA (US)

(21) Appl. No.: 18/933,361

(22) Filed: Oct. 31, 2024

Related U.S. Application Data
(60) Provisional application No. 63/596,598, filed on Nov. 6, 2023.

(51) Int. Cl. G01C 21/36; G01C 21/00

(52) U.S. Cl. CPC G01C 21/367; G01C 21/3878

(57) ABSTRACT

Disclosed are devices, systems and methods for displaying a map for a user. A method of displaying a map for a user comprises: receiving, from a user device, a request to display the map for a geographical region around a vehicle, wherein the request identifies one or more layers of the map; retrieving, in response to the request, map data corresponding to the geographical region from a map database that stores a multi-layer representation of the geographical region; selecting, in response to the request, the one or more layers from the multi-layer representation; and displaying the map on a display of the user device based on the request.

### CROSS-REFERENCE TO RELATED APPLICATIONS

This document claims priority to and the benefit of U.S. Provisional Application No. 63/596,598, filed on Nov. 6, 2023. The aforementioned application of which is incorporated herein by reference in its entirety.

### TECHNICAL FIELD

This document relates to tools (systems, apparatuses, methodologies, computer program products, etc.) for semi-autonomous and autonomous control of vehicles.

### BACKGROUND

Autonomous vehicle navigation can have important applications in the transportation of people, goods, and services. In order to ensure the safety of the vehicle, as well as people and property in the vicinity of the vehicle, various applications are being employed by the vehicle to process various measurement data and provide information for drivers of the vehicle.

### SUMMARY

Disclosed are devices, systems and methods for displaying a map for a user. The disclosed technology can be applied to display a map for a geographical region around a vehicle.

In one aspect, a method of displaying a map for a user is provided. The method comprises: receiving, from a user device, a request to display the map for a geographical region around a vehicle, wherein the request identifies one or more layers of the map; retrieving, in response to the request, map data corresponding to the geographical region from a map database that stores a multi-layer representation of the geographical region; selecting, in response to the request, the one or more layers from the multi-layer representation; and displaying the map on a display of the user device based on the request.

In another aspect, a system of displaying a map for a user is provided. The system comprises: a communication interface configured to communicate with one or more vehicles; a database storing a multi-layer representation of a geographical region and sensor data captured by sensors of the one or more vehicles; and a processor coupled to the storage and communicable with the one or more vehicles through the communication interface. The processor is configured to: receive, from a vehicle, a request to display the map for the geographical region around a vehicle, wherein the request identifies one or more layers of the map; retrieve, in response to the request, map data corresponding to the geographical region from the storage; select the one or more layers from the multi-layer representation; and display the map on a display installed in the vehicle based on the request.

In another aspect, a computer-readable storage medium having code stored thereon is provided. The code, upon execution by one or more processors, causes the one or more processors to implement a method comprising: receiving, from a user device associated with a user, a request to display a map for a geographical region around a vehicle; retrieving, in response to the request, map data having different file formats and configured in one or more layers; sending, to the device associated with the user, a list of selectable map features that include at least one of one or more selectable layers or one or more selectable map elements having element categories that correspond to lanes, road marks, boundaries, traffic lights, bounds, intersections, property types, or speed limits; receiving, from the device associated with the user, a selection of at least one map feature among the selectable map features; and displaying the map on a display of the user device based on the selection of the at least one map feature.

In another exemplary aspect, the above-described method is embodied in a non-transitory computer readable storage medium. The non-transitory computer readable storage medium includes code that when executed by a processor, causes the processor to perform the methods described in this patent document.

In yet another exemplary embodiment, a device that is configured or operable to perform the above-described methods is disclosed.

The above and other aspects and features of the disclosed technology are described in greater detail in the drawings, the description and the claims.

### BRIEF DESCRIPTION OF THE DRAWINGS

FIG. 1 shows an example diagram of a map viewer system based on some implementations of the disclosed technology.

FIG. 2 shows an example flowchart that illustrates a method of displaying a map for a user based on some implementations of the disclosed technology.

FIG. 3 shows example functions/operations of a map viewer application based on some implementations of the disclosed technology.

FIG. 4 shows an example window of a map viewer application as an option for display based on some implementations of the disclosed technology.

FIGS. 5A and 5B show different map views based on corresponding layers of multi-layer representation of a geographical region based on some implementations of the disclosed technology.

FIG. 6A shows an example of a portion of a map displayed for a user based on some implementations of the disclosed technology.

FIG. 6B shows an example listing of information of selected map elements based on some implementations of the disclosed technology.

FIGS. 7A, 7B and 8 show example diagrams illustrating a plotting process based on some implementations of the disclosed technology.

FIG. 9 shows an example communication connection between a server device and a client device based on some implementations of the disclosed technology.

FIG. 10 shows an example diagram of a client device that is implemented in a vehicle.

### DETAILED DESCRIPTION

Maps are visual representations of information pertaining to the geographical location of natural and man-made structures. There are several map applications that allow users to select display options among several scales and map viewing modes such as a map mode that presents a traditional road-map view, a satellite mode that presents a photograph taken above the geographical region, or a street-level mode that presents a photograph taken of the surrounding area at ground level. The display options provided to users, however, are still limited and there is not much flexibility to customize maps provided to users.

Maps displayed on computing devices usually include various items such as buildings, restaurants, houses, stores, roads, railroads, hills, rivers, lanes within a prescribed geographic region. In some cases, additional information such as phone numbers, open hours, etc. of the restaurants and stores are also provided on the map. Some of the information displayed on the map can be utilized to increase the accuracy level of maps provided for vehicles, while others are not related to increasing the accuracy level of the maps.

Various implementations of the disclosed technology provide techniques for providing maps for users, which improves accuracy level and provides flexibility to customize the maps for users. In some implementations,

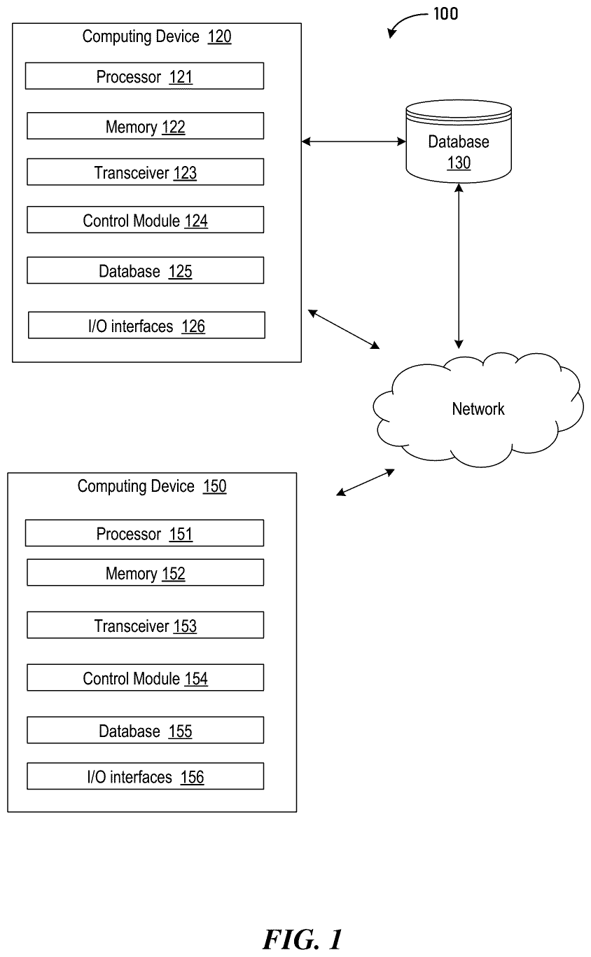

FIG. 1 shows an example diagram of a map viewer system based on some implementations of the disclosed technology.

The map viewer system 100 includes a computing device 120, a database 130, and a computing device 150. The computing device 120 may correspond to a server device that is located outside of a vehicle and configured to process requests to display a map from the computing device 150 (e.g., a computing device inside the vehicle, a passenger electronic device, or others) via network. The computing device 120 includes at least one processor 121, a memory 122, a transceiver 123, a control module 124, a database 125, and an input/output (I/O) interface 126. In other embodiments, additional, fewer, and/or different elements may be used to configure the computing device 120.

The memory 122 may store instructions and applications to be executed by the processor 121. The memory 122 is an electronic holding place or storage for information or instructions so that the information or instructions can be accessed by the processor 121. The memory 122 can include, but is not limited to, any type of random access memory (RAM), any type of read-only memory (ROM), any type of flash memory, such as magnetic storage devices (e.g., hard disk, floppy disk, magnetic strips, etc.), optical disks (e.g., compact disc (CD), digital versatile discs (DVD), etc.), smart cards, flash memory devices, etc. The instructions upon execution by the processor 121 configure the computing device 120 to perform the operations, which will be described in this patent document. The instructions executed by the processor 121 may be carried out by a special purpose computer, logic circuits, or hardware circuits. The processor 121 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 121 can perform the operations called for by that instruction. In some implementations, the instructions stored in the memory 122 may allow to generate a map for display on a screen of the same or another device.

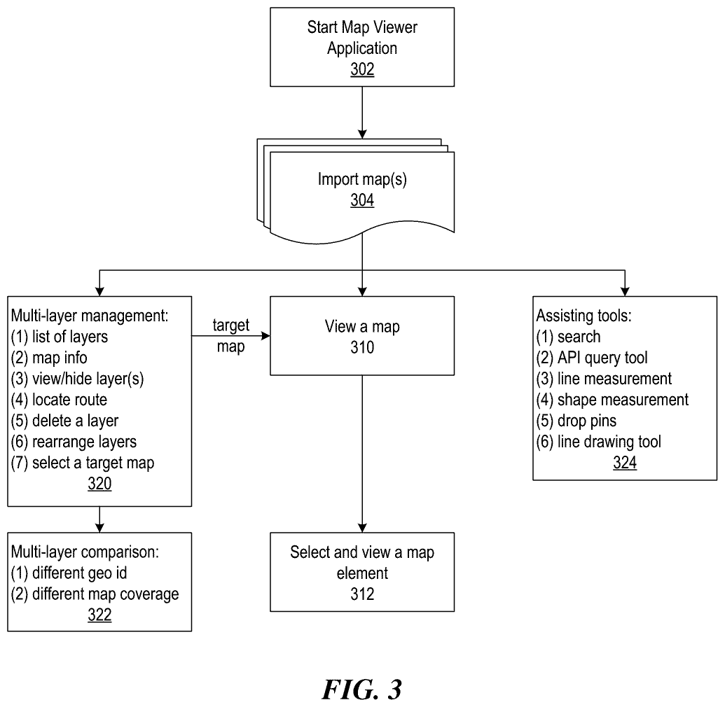

In some implementations, the map viewer application, which is to be described in detail with reference to FIG. 3, is stored in memory 122 and may include additional routines or cooperate with additional routines to facilitate the generation and the display of map information. The additional routines may use location-based information associated with the geographic region to be mapped. In some implementations, the application stored in the memory 122 and executed by the processor 121 is a web browser that controls a browser window provided by the operating system that is also stored in the memory 122 and displayed by the user interfaces 126. During operation, the web browser retrieves a resource, such as a web page, from a web server (not shown) via network (e.g., the Internet). The resource may include content such as text, images, video, interactive scripts, etc. and describe the layout and visual attributes of the content using HTML or another suitable mark-up language. In some implementations, the resource requests that a portion of the browser window be allocated for display of map data, and provides an application programming interface (API) for accessing the map data and the image data from multiple sources. Once the computing device 120 receives the resource, the application displays the received content in the browser window, allocates a portion of the window in the form of an embedded window for display of map data and the runway with images, and executes the API to retrieve the map data and the image data and render the received data within the embedded window. Thus, according to this implementation, the computing device 120 may specify how map data is to be displayed within the embedded window on the computing device 150.

The processor 121 operably couples with the memory 122, the transceiver 123, the control module 124, the database 125, and the I/O interface 240, to receive, send, and process information and to control the operations of the computing device 120. The processor 121 may retrieve a set of instructions from a permanent memory device, such as a ROM device, and copy the instructions in an executable form to a temporary memory device that is generally some form of RAM. In some implementations, the computing device 120 can include a plurality of processors that use the same or a different processing technology. The transceiver 123 may include a transmitter and a receiver. In some embodiments, the computing device 120 comprises a transmitter and a receiver that are separate from one another but functionally form a transceiver. The transceiver 123 transmits or sends information or data to another device (e.g., another server, a computing device inside the vehicle, a passenger mobile device, etc.) and receives information or data transmitted or sent by another device (e.g., another server, a PED, etc.).

The control module 124 of the computing device 120 is configured to perform operations to assist the computing device 120. In some implementations, the control module 124 can be configured as a part of the processor 121. In some implementations, the control module 124 can operate machine learning/artificial intelligence (AI) applications that perform various types of data analysis to automate analytical model building. Using algorithms that iteratively learn from data, machine learning applications can enable computers to learn without being explicitly programmed. The machine learning/AI module may be configured to use data learning algorithms to build models to interpret various data received from the various devices or components to detect, classify, and/or predict future outcomes. Such data learning algorithms may be associated with rule learning, artificial neural networks, inductive logic programming, and/or clustering. In some implementations, the control module 124 may assist the computing device 120 to perceive their environment and take actions that maximize the effectiveness of the operations performed by the computing device 120.

The I/O interfaces 126 enables data to be provided to the computing device 120 as input and enables the computing device 120 to provide data as output. In some embodiments, the I/O interfaces 126 may enable user input to be obtained and received by the computing device 120 (e.g., via a touch-screen display, buttons, or switches) and may enable the computing device 120 to display information. In some embodiments, devices, including touch screen displays, buttons, controllers, audio speakers, or others, are connected to the computing device 120 via I/O interfaces 126. The I/O interfaces 126 are capable of facilitating wired and/or wireless communication with another device (e.g., computing device 150) via various communication protocols such as Internet, Wi-Fi, Bluetooth, etc.

In some implementations, the map viewer system includes database 130 that is communicatively coupled to the computing device 120 and located outside of the computing device 120. The database 130 may include map data for the majority of Earth's surface and additional location-related information associated with areas covered by a map. Although the single database 130 is shown in FIG. 1, there can be multiple databases. When the computing device 120 needs to obtain map data that is not available in the database 125, the computing device 120 may obtain the map data from the database 130 for serving the map to the vehicle or others.

The computing device 120 generates a map to be displayed for a user and the generated map is sent via network from the computing device 120 to the computing device 150. The computing device 150 may be communicatively connected to the computing device 120 in a client-server relationship wherein the computing device 120 may be described as the server device and the computing device 150 may be described as the client device. The computing device 150 operates as the client device which makes the request to display the map. In some implementations, the computing device 150 can be located inside the vehicle. In some other implementations, the computing device 150 can be located outside of the vehicle.

In some implementations, the computing device 150 is implemented as the control unit installed in the vehicle. The computing device 150 includes at least one processor 151, a memory 152, a transceiver 153, a control module 154, a database 155, and an input/output (I/O) interfaces 156. The operation of each element of the computing device 150 is similar to those of the computing device 120 and thus the description as discussed for the computing device 120 can be applied to the computing device 150. The I/O interfaces 156 may include an output module, e.g., screen (not shown in FIG. 1). Stored within the memory 152 is an operating system (OS) and at least one application executed by the processor 151. The application is capable of facilitating display of the map and photographic images received from the computing device 120 onto the screen. The operating system may be any type of operating system capable of being executed by the computing device 150. A graphic card interface module (GCI) and a user interface module may be also stored in the memory 152.

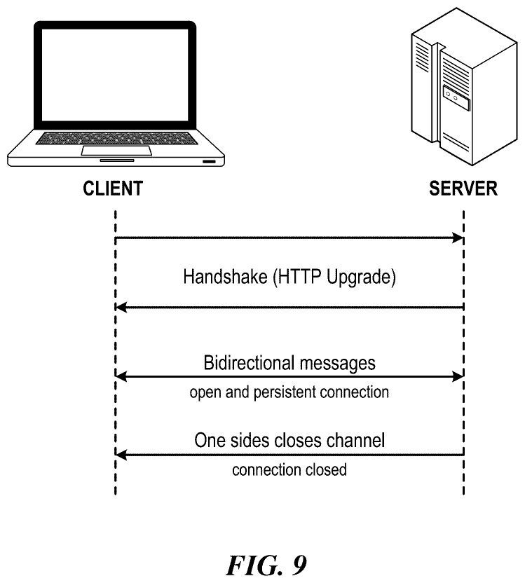

In some implementations, the computing device 120 operating as the server device interacts with the computing device 150 operating as the client device such that the computing device 150 can be provided with the desired map from the computing device 120 based on communications between the computing device 120 and the computing device 150. FIG. 9 shows an example connection between a server device and a client device based on some implementations of the disclosed technology. In the example, a WebSocket protocol is used to establish and control an end-to-end connection between the client device and the server device. The WebSocket protocol is designed to work over HTTP (Hypertext Transfer Protocol) and allow the communication in both directions. To achieve compatibility with HTTP, the WebSocket handshake uses the HTTP Upgrade header in order to change from the HTTP protocol to the WebSocket protocol. Referring to FIG. 9, the three main interactions, which include 1) handshake using HTTP upgrade, 2) bidirectional messages, and 3) one sides closes channel, are performed. The WebSocket protocol is the example only and the server device and the client device can interact with each other using other protocols.

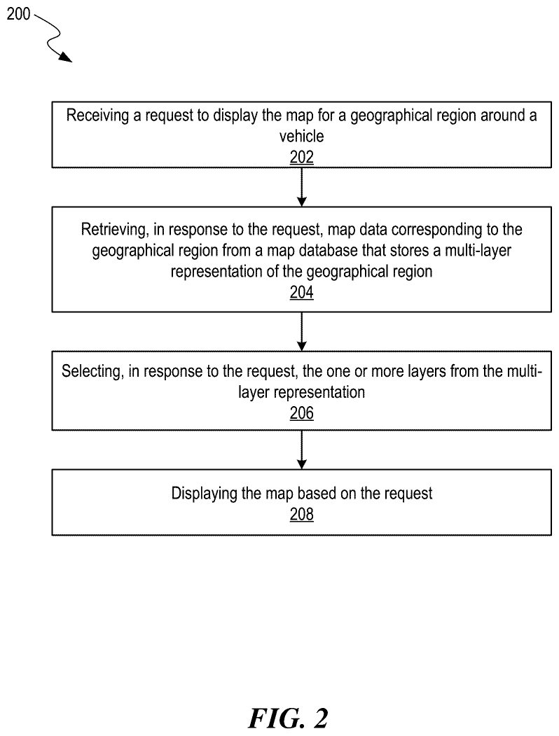

FIG. 2 is an example flowchart that illustrates a method 200 of displaying a map for a user based on some implementations of the disclosed technology. The operations as shown in FIG. 2 may be implemented by the computing device 120 (e.g., an application stored in the memory 122 of the computing device 120) operating as the server device.

At operation 202, the computing device 120 receives a request to display the map for a geographical region around a vehicle from the computing device 150. In some implementations, the computing device 150 may be implemented in the vehicle and high-definition map for the geographical region including various map elements is provided for the vehicle. As will be discussed in detail with reference to FIG. 3, the map to be rendered supports a multi-layer representation of the geographical region and includes various map elements such as lanes, road markers, traffic lights, bounds, lane reference points, intersections.

The map elements such as lanes, road markers, traffic lights, bounds, lane reference points, intersections may correspond to map data present on high-definition maps (HD maps). The processor 121 of the computing device 120 is capable of obtaining the map elements available on HD maps. For example, the computing device 120 may obtain such map data by being connected to an external HD map system provided by HD map providers. In some implementations, the computing device 120 may process the recognition, judgment and operation that help the computing device 120 to obtain such map data. For example, the recognition is implemented by receiving various data from sensors equipped on the vehicles, which include Light Detection and Ranging (LiDAR), radar, camera, a Light Amplification by Stimulated Emission of Radiation (LASER) sensor, an ultrasound sensor, an infrared sensor, and/or GNSS/IMU. Those sensors measure the inter-vehicular distance and collect the situation of pedestrians and traffic information in the surrounding areas. The computing device 120 may be in communication with various vehicles to receive data from the sensors from the vehicles. In some implementations, the computing device 120 may operate the judgement including detection, prediction and planning needs the self-localization based on the sensors embedded on the vehicles and HD Map, which is one of the information to decide the next behavior of the vehicles and then the operation will be executed based on the recognition and the judgement.

In some implementations, when the computing device 150 makes the request to display the map for the geographical region around the vehicle, the request may identify a lane associated with the vehicle. An image identifying engine may be stored in the computing device 150 to identify all the photographic images associated with objects (e.g., map elements) located within the geographic region represented by the map that are accessible to the computing device 150.

At operation 204, the computing device 120, in response to the request, retrieves map data corresponding to the geographical region from a map database that stores a multi-layer representation of the geographical region. The map data can be retrieved from the database 125 of the computing device 120 and/or the database 130 outside of the computing device. When the computing device 120 receives the request from the computing device 150, which identifies the lane associated with the vehicle, the computing device 120 may provide additional map data specified for the lane, e.g., which road signals apply to which lane. The computing device 120 may retrieve additional map data from the database 125 and/or the database 130.

At operation 206, the computing device 120 selects, in response to the request, the one or more layers from the multi-layer representation. At operation 208, the computing device 120 displays the map based on the request. The computing device 120 may include logics/software applications to render the map based on the request and display the map at a display of the computing device 150. In some implementations, the display of the computing device 150 can include a monitor, screen, or any other display components.

FIG. 3 shows example functions/operations of a map viewer application based on some implementations of the disclosed technology. In some implementations, the operations as shown in FIG. 3 may be implemented by the computing device 120 operating as the server device as shown in FIG. 1 and being in communication with the client device as shown in FIG. 1. Thus, the operations may proceed based on the selections/requests from the user on the client device. As discussed below, the map viewer application provides or presents certain information (e.g., a list of map elements, comparison results of multiple layers of the multi-layer representation of a geographical region, etc.). Such providing or presenting may include sending a message or notification including the corresponding information to the client device, displaying the corresponding information visually or non-visually on a display of the client device, or others. In some implementations, at least some of the operations as shown in FIG. 3 may be implemented by the computing device 150 operating as the client device as shown in FIG. 1. When at least some of the operations as shown in FIG. 3 are implemented by the computing device 150, such operations may be performed by the control module/unit that is in communication with the user interface (UI) such that the operations proceed based on the selections/requests from the user. In some implementations, the map viewer application may be implemented as an application software programs (“apps”) to perform predetermined functions/operations.

At operation 302, the map viewer application starts. The map viewer application may be initiated in various manners. In some implementations, the map viewer application may start in response to receiving a request to display the map for a geographical region around a vehicle. The map viewer application may be provided as one option to display the map for users. In the example, the default setting for the navigation system of the vehicle may be stored such that the latest user version map viewer application is provided with the lasted user version map file. When the user selects to run the navigation system, the map viewer application may be initiated. In some implementations, the map viewer application may start separately from the request from the vehicle. The server device may provide an option to initiate the map viewer application by running a related app/tool. In some implementations, when the map viewer application starts, an initial map is provided and then the initial map is being updated based on selections/requests from the user or predetermined algorithms. In some implementations, when the map viewer application starts, a list of map files can be provided such that the user can select one among the map files included in the list and the user can select the option to display the map file with the map viewer application.

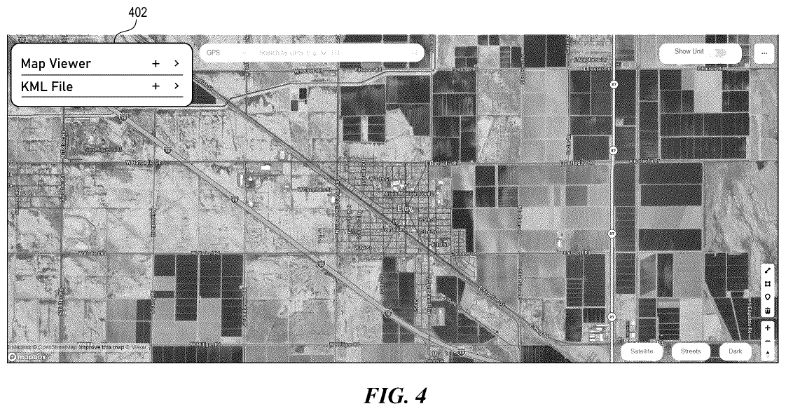

FIG. 4 illustrates an example of a window of a map viewer application as one option for the display. In FIG. 4, the kml (Keyhole Markup Language) file is shown in the text box 402 as the example of the map file to be imported for the display. For example, the list of map files can include various map files having different formats from each other, which include a tsmap (TypeScript map) file, kml (Keyhole Markup Language) file, and others. The tsmap file is a source map file that maps between the JavaScript code and the TypeScript source file that created it. The kml file is the file format used to view and share Google Earth information. The kml file stores geographic data and content associated with Google Earth. The tsmap file and the kml file are examples of map files only and the implementation of the disclosed technology is not limited to the specific file formats.

At operation 304, one or more map files may be imported. The map viewer application supports the multi-layer management in which multiple map files are imported for displaying the map. When multiple map files are imported, each map file may be displayed in each layer. In some implementations, the multiple map files to be imported to display the map for the user correspond to map files having different file formats. For example, the multiple map files include a tsmap file and a kml file such that the first layer of the multi-layer representation corresponds to map data from the tsmap file and the second layer of the multi-layer representation corresponds to map data from the kml file. To import the tsmap file, the user may provide at least one of i) map feature, ii) version, or iii) map series (user map feature as a filter to limit map series options). In some implementations, the predetermined algorithm may be stored to import the tsmap file without any input from the user. In some implementations, multiple tsmap files can be imported as long as the system performance allows. In some implementations, one or more kml files may be imported. To import the kml file, the user may provide at least one of i) a kml file path, ii) drag and drop of a kml file, or iii) a selection of the kml file. In some implementations, the predetermined algorithm may be stored to import the tsmap file without any input from the user.

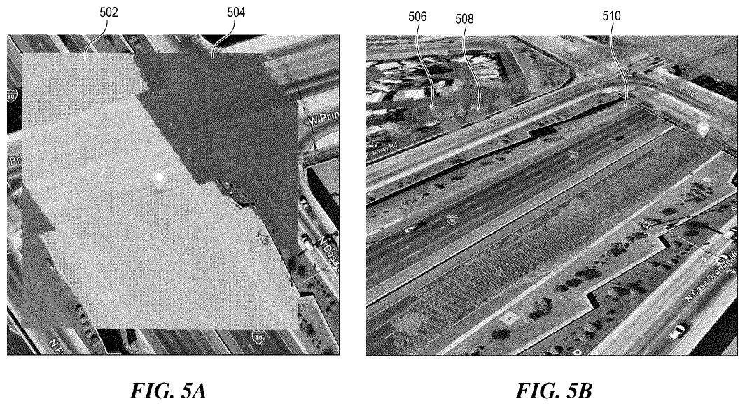

In some implementations, the multiple map files to be imported to display the map for the user correspond to map data from different sources. For example, the first layer may correspond to a first type of image sensor and the second layer may correspond to a second type of image sensor. For example, the first type of image sensor and the second type of the image sensor are the camera and the lidar, respectively. Thus, it is possible to display the same geographical region in various manners, e.g., i) either the camera view or the lidar view using the hide layer function or ii) the view in which both the camera view and the lidar view are combined. FIGS. 5A and 5B show examples of different views based on different sources. FIG. 5A shows a terrain heatmap view illustrating terrains 502 and 504 and FIG. 5B shows the lidar view illustrating elements 506, 508, and 510. The map data corresponding to the map views shown in FIGS. 5A and 5B can construct different layers of the multi-layer representation of the map for the user.

At operation 320, the map viewer application provides a list of multi-layer management options to the user. In some implementations, the application programming interface (API) may be implemented to provide the list of the multi-layer management options to the user and receive one or more selections of the multi-layer management options from the user. In some implementations, the selections of one or more multi-layer management options may be made separately from the user according to a predetermined algorithm stored in the server device. The multi-layer management options include following characteristics:
Display a list of layers: The map viewer application may display a list of layers that are currently imported.
Display map information: Each layer may include map information for the user to distinguish each map. In some implementations, the map information includes a layer number, a map feature name, a map version, map start/end GPS information.
View/hide layer(s): The map viewer application may provide an option to view/hide a layer among multiple layers that are currently imported. As mentioned above, the map is displayed in the multi-layer representation of the geographical region when the different layers correspond to map data from different map files or different sources. The view/hide layer function allows the user to select to view map data corresponding to a particular layer (by selecting the option of “View layer”) or select to hide map data corresponding to a particular layer (by selecting the option of “Hide layer”). In the example, when the first layer corresponds to the map data obtained from a first map file (e.g., the kml file) and the second layer corresponds to the map data obtained from a second map file (e.g., the tsmap file), if the user selects “Hide layer” for the second layer, the map is displayed to show the map data corresponding to the first layer only. In the example, when the first layer may correspond to map data from the camera and the second layer may correspond to map data from the lidar, if the user selects “View layer” for the second layer, the map is displayed to show the map data corresponding to the second layer only. Thus, it is possible for the user to customize the map view displayed on the map.
Locate route/point: The map viewer application may provide a function to locate a specific route or geological point on a layer. For example, FIGS. 5A and 5B show examples of different map views showing the maps displayed to the user and represented in multiple layers.
Delete a layer: The map viewer application may provide an option to delete a layer among multiple layers that are currently imported.
Rearrange a layer: The map viewer application may provide an option to drag and rearrange layer orders. The dragging and rearranging layer may change a map view to be displayed for the user.
Select a target layer: The map viewer application may provide an option to select and utilize a target layer. The target layer may be selected by the user from the list of layers that are currently imported. When a layer is selected by the user as the target layer, the user shall be able to utilize map data corresponding to the target layer as a main map. In some implementations, all the queries and functions shall affect the target layer only, except multi-layer comparison function.

At operation 322, the map viewer application performs the multi-layer comparison function that compares differences among the layers. In some implementations, the multi-layer comparison function may be performed based on a selection by the user for the comparison of the layers. Thus, it is possible for users to compare and contrast two or more maps to easily tell the differences among layers. The multi-layer comparison function can provide a comparison result by description and/or visualization. The multi-layer comparison function may implement at least one of the following characteristics:
The map viewer application may provide a function to highlight the differences of the map elements in map view. The map elements will be further discussed later in this document in relation to the operation 216.
The map viewer application may provide a list of differences with element name and geo id. As further discussed in relation to the map elements, each map element has an element name and a geo_id which identifies a geographical location of the map element. The multi-layer comparison function of the map viewer application provides the comparison results by identifying the differences using the element name and geo id. In some implementations, for each map, the map viewer application may provide a list of map element names with geo ids which are different from other layers. In some implementations, if a target map is selected, the list will only show the geo id from the target map that are different from the other(s). In some implementations, the map viewer application may be able to detect geo id differences among layers. In some implementations, the map viewer application may re-calculate the differences if a layer is added or deleted.
The map viewer application may provide an option to view/hide differences in highlight.
Map differences may include 1) map coverage and 2) map elements (geo id).

At operation 310, the map viewer application provides a map. The map viewer application may render the map based on the selections from the user or the predetermined algorithm. In some implementations, the map viewer application allows the user to view different types of map files.
Different types of map files may include, for example, the tsmap file and the kml file.
The map viewer application may display map information, which includes the following:
   map feature name
   version
   map series
   start/end gps (global positioning system)
   route visualization
The map viewer application may display kml information, which includes the following:
   kml file name
   start/end gps

The map information and the kml information is stored in the database of the server device or external database. The map information and the kml information may be associated with a specific geographical area (e.g., start/end gps). The map information and the kml information can be displayed for the user in various manners, e.g., in the text box on the screen of the client device.

At operation 312, the map viewer application may allow the user to select and view a map element displayed on the map. The map viewer application may provide a list of map elements in the map such that the user can make a selection for a particular map element among the map elements in the map.
The map elements may include at least one of the following:
   element name (lane/road marker/traffic light/bound/lane reference point/intersection)
   geo_id
   left bound
   right bound
   next bound
   previous bound
   left lane
   right lane
   intersection
   next lane
   previous lane
   property type
   speed limit
   posted speed limit
   time to end
   distance to end
   element length on map

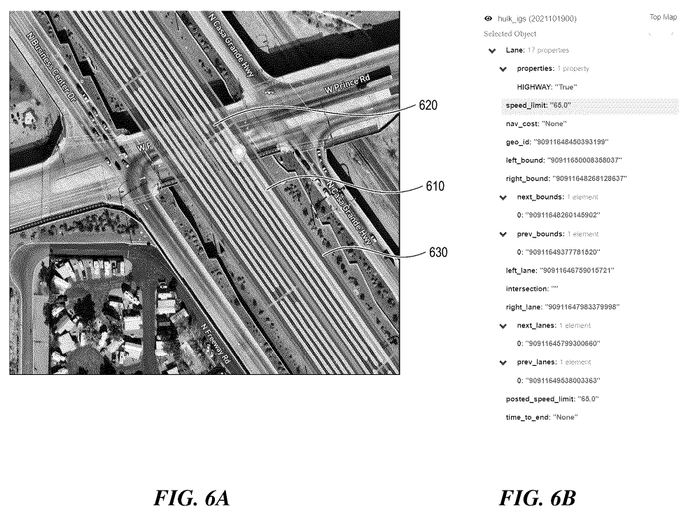

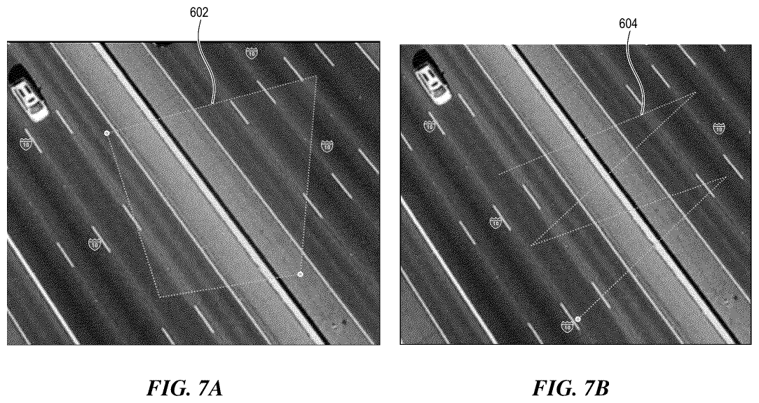

FIG. 6A shows an example of a portion of a map displayed for the user and FIG. 6B show an example of listing of information of the selected map elements. In the example of FIG. 6A, the portion of the map shows the lanes 610 and the bounds 620 as the selectable items in the map. In some implementations of the disclosed technology, the map elements can be displayed on the map as the selectable items (or icons) using web user interface designs to allow the user to make a selection of any selectable item. For example, when the user selects the lane 610 displayed in the portion of the map, the related information of the lane 610 is provided as shown in FIG. 6B. Thus, it is possible for the user to be provided with very high level of accurate and detailed information for the geographical region around the vehicle.

At operation 216, the map viewer application may allow the user to select and view a map element displayed on the map. The map viewer application may provide a list of map elements in the map such that the user can make a selection for a particular map element among the map elements in the map.
The map viewer application may provide an assisting tool to distinguish overlapped map elements. In some implementations, the map viewer application may offer an option to hover and highlight an object to provide the user a hint that which map element the user is about to click on. In some implementations, the map viewer application provides an option to right click on map and view element information, which includes at least one of current GPS coordinates, current ENU (East-North-Up) coordinates, unit index, a layer number, or a map element name.
The map viewer application may locate a map element when a map element is selected by the user.
The map viewer application may locate the map element when the user switch to a map element via metadata panel.
The map viewer application may provide hotkeys for user to switch between map elements:
   ←: previous element
   →: next element
   Tab key: next element

At operation 324, the map viewer application may provide assisting tools for the user to perform various actions on the map. The assisting tools may include the following:
search by (gps/geo id/map element name)
API query tool (for developers)
line measurement
shape measurement
drop pins
line drawing tool (does not impact map)
auto termination
   i. The map viewer application may signal on browser tab when the session is about to end in 1 minute
   ii. The map viewer application has a pop-up window for use to confirm to continue/end the session
hotkeys for switching to next/previous element
list of hotkeys

Although not shown, the map viewer application may provide an overall map view settings and layer-based view settings. Thus, the map viewer application may allow the user to select either the overall map view or the layer-based view as the user preference view setting.
The overall map view settings may include the following:
street view/satellite view/dark mode view
zoom in/out
GPS/ENU coordinates
unit view
highlight differences
The layer-based view settings may include the following:
view lane
view road marker
view traffic light
view bound
view lane reference point
view intersection
view speed limit

The performance of the map viewer application can be enhanced to improve user experiences by implementing at least one of the following:
The map viewer application shall go directly to the viewer or have buffering status when initiating
The map viewer application shall display map and map elements in <3 seconds or have buffering status
The map viewer application shall display map and map elements in <3 seconds after zoom in/out
The map viewer application shall display map element information and locate element in less than 3 seconds after user selection. In some implementations, the map viewer application allows users to have minimum wait time in loading maps and other information queries or at least be notified about loading status to ensure their requests are in progress.

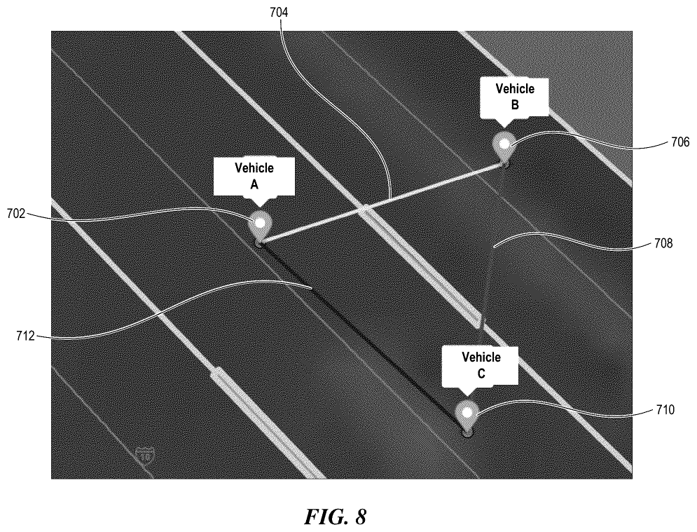

According to the implementations of the disclosed technology, users can be provided with a map from different map files, e.g., the tsmap file and the kml file, and map elements. The map elements are selectable by the users and upon the selection of the users, additional map information can be retrieved for various purposes including viewing, verifying, debugging and so on. FIGS. 7A, 7B, and 8 show example diagrams illustrate a plotting process based on some implementations of the disclosed technology. The plotting process can be performed when the user prefers the plotting rather than clicking menu buttons. FIGS. 7A and 7B show the polygon 602 and the polyline 604 are plotted for the purpose, e.g., viewing, verifying, debugging. In the example of FIG. 8, the plotting process using lines 704, 708, 712, the distances among the vehicles 702, 706, 710 can be further evaluated.

Various implementations of the disclosed technology provide various information that is not available from the currently available maps. In addition, various implementations of the disclosed technology can improve the map viewing experience in a manner that is more responsive and complementary during the map viewing session.

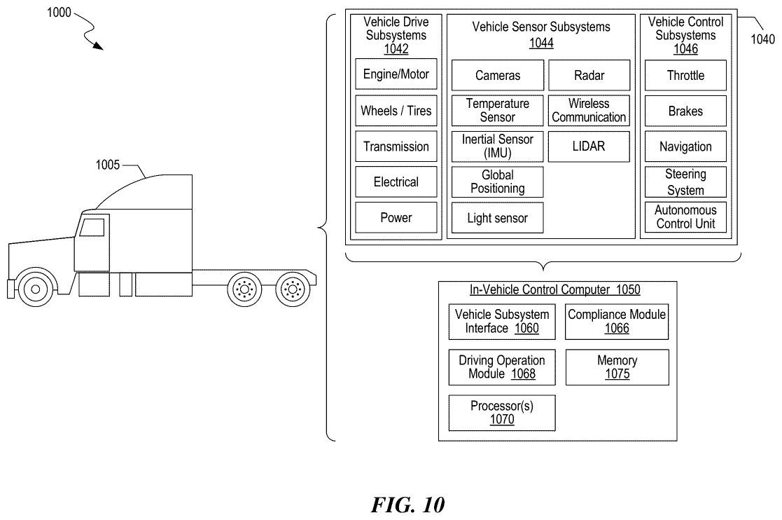

The map displaying schemes as described in this patent document can be applied for semi-autonomous and autonomous vehicles to provide map information that is more accurate and also customized for users in the vehicles. FIG. 10 shows a system 1000 that is included an autonomous or semi-autonomous vehicle 1005. The vehicle 1005 includes a plurality of vehicle subsystems 1040 and an in-vehicle control computer 1050. The in-vehicle control computer 1050 may correspond to the computing device 150 as shown in FIG. 1. The plurality of vehicle subsystems 1040 includes vehicle drive subsystems 1042, vehicle sensor subsystems 1044, and vehicle control subsystems. An engine or motor, wheels and tires, a transmission, an electrical subsystem, and a power subsystem may be included in the vehicle drive subsystems.

Vehicle sensor subsystems 1044 can include sensors for general operation of the vehicle 1005, including those which would indicate a malfunction in the AV or another cause for an AV to perform a limited or minimal risk condition (MRC) maneuver. The sensors for general operation of the vehicle may include cameras, a temperature sensor, an inertial sensor (IMU), a global positioning system, a light sensor, a LIDAR system, a radar system, and wireless communications supporting network available in the vehicle 1005. The in-vehicle control computer 1050 can be configured to receive or transmit data from/to a wide-area network and network resources connected thereto. A web-enabled device interface (not shown) can be included in the vehicle 1005 and used by the in-vehicle control computer 1050 to facilitate data communication between the in-vehicle control computer 1050 and the network via one or more web-enabled devices. Similarly, a user mobile device interface can be included in the vehicle 1005 and used by the in-vehicle control system to facilitate data communication between the in-vehicle control computer 1050 and the network via one or more user mobile devices. The in-vehicle control computer 1050 can obtain real-time access to network resources via network. The network resources can be used to obtain processing modules for execution by processor 1700, data content to train internal neural networks, system parameters, or other data. In some implementations, the in-vehicle control computer 1050 can include a vehicle subsystem interface 1060 that supports communications from other components of the vehicle 1005, such as the vehicle drive subsystems 10421042, the vehicle sensor subsystems 144, and the vehicle control subsystems 1046.

The vehicle control subsystem 1046 may be configured to control operation of the vehicle 1005 and its components. Accordingly, the vehicle control subsystem 1046 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the vehicle 1005. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 1005. The navigation unit may additionally be configured to update the driving path dynamically while the vehicle 1005 is in operation. In some embodiments, the navigation unit may be configured to incorporate data from the GPS device and one or more predetermined maps so as to determine the driving path for the vehicle 1005. The steering system may represent any combination of mechanisms that may be operable to adjust the heading of vehicle 1005 in an autonomous mode or in a driver-controlled mode.

The autonomous control unit may represent a control system configured to identify, evaluate, and avoid or otherwise negotiate potential obstacles in the environment of the vehicle 1005. In general, the autonomous control unit may be configured to control the vehicle 1005 for operation without a driver or to provide driver assistance in controlling the vehicle 1005. In some embodiments, the autonomous control unit may be configured to incorporate data from the GPS device, the RADAR, the LiDAR (also referred to as LIDAR), the cameras, and/or other vehicle subsystems to determine the driving path or trajectory for the vehicle 1005. The autonomous control unit may activate systems to allow the vehicle to communicate with surrounding drivers or signal surrounding vehicles or drivers for safe operation of the vehicle.

An in-vehicle control computer 1050, which may be referred to as a VCU (vehicle controller unit), includes a vehicle subsystem interface 1060, a driving operation module 1068, one or more processors 1070, a compliance module 1066, a memory 1075, and a network communications subsystem (not shown). The in-vehicle control computer 1050 may correspond to the computing device 150 as shown in FIG. 1. Thus, the in-vehicle control computer 1050 may further include the transceiver, the control module, the database, I/O interfaces. Here, the operations/element of the in-vehicle control computer 1050 is, which are not described in FIG. 1, may be mainly discussed. The in-vehicle control computer 1050 controls many, if not all, of the operations of the vehicle 1005 in response to information from the various vehicle subsystems 1040. The one or more processors 1070 execute the operations that allow the system to determine the health of the AV, such as whether the AV has a malfunction or has encountered a situation requiring service or a deviation from normal operation and giving instructions. Data from the vehicle sensor subsystems 1044 is provided to in-vehicle control computer 1050 so that the determination of the status of the AV can be made. The compliance module 1066 determines what action needs to be taken by the vehicle 1005 to operate according to the applicable (i.e., local) regulations. Data from other vehicle sensor subsystems 1044 may be provided to the compliance module 1066 so that the best course of action in light of the AV's status may be appropriately determined and performed. Alternatively, or additionally, the compliance module 1066 may determine the course of action in conjunction with another operational or control module, such as the driving operation module 1068.

The memory 1075 may contain additional instructions as well, including instructions to transmit data to, receive data from, interact with, or control one or more of the vehicle drive subsystem 1042, the vehicle sensor subsystem 1044, and the vehicle control subsystem 1046 including the autonomous Control system. The in-vehicle control computer 1050 may control the function of the vehicle 1005 based on inputs received from various vehicle subsystems (e.g., the vehicle drive subsystem 1042, the vehicle sensor subsystem 1044, and the vehicle control subsystem 1046). Additionally, the in-vehicle control computer 1050 may send information to the vehicle control subsystems 1046 to direct the trajectory, velocity, signaling behaviors, and the like, of the vehicle 1005. The autonomous control vehicle control subsystem may receive a course of action to be taken from the compliance module 1066 of the in-vehicle control computer 1050 and consequently relay instructions to other subsystems to execute the course of action.

Various techniques preferably incorporated within some embodiments may be described using the following solution-based format.

1. A method of displaying a map for a user, comprising: receiving, from a user device, a request to display the map for a geographical region around a vehicle, wherein the request identifies one or more layers of the map; retrieving, in response to the request, map data corresponding to the geographical region from a map database that stores a multi-layer representation of the geographical region; selecting, in response to the request, the one or more layers from the multi-layer representation; and displaying the map on a display of the user device based on the request. This method is described with reference to FIG. 2.

2. The method of solution 1, wherein the multi-layer representation of the geographical region configures multiple layers based on a source of the map data such that a first layer corresponds to map data obtained from a first type of image sensor and a second layer corresponds to map data obtained from a second type of image sensor.

3. The method of solution 1, wherein the map data includes map elements that are associated with element categories, each map element categorized as one of lanes, road marks, boundaries, traffic lights, bounds, intersections, property types, and speed limits.

4. The method of solution 3, further comprising: presenting, to the user device, a list of map elements included in the map; upon a selection by the user of a particular map element having a particular element category, updating the map to display map elements corresponding to the particular element category.

5. The method of solution 4, wherein the particular map element corresponds to a particular lane and the map is updated to map data including road marks, traffic lights, and speed limits that are applied to the particular lane.

6. The method of solution 3, further comprising: presenting, to the user device, a list of map elements included in the map, upon a selection by the user of a particular map element having a particular element category, updating the map to remove map elements corresponding to element categories different from the particular element category.

7. The method of solution 1, further comprising: comparing differences of the map data among one or more layers of the multi-layer representation of the geographical region; and visually presenting the differences on the map displayed on the display of the user device.

8. The method of solution 1, wherein the map database includes at least two map data having different file formats from each other.

9. A system of displaying a map for a user, comprising: a communication interface configured to communicate with one or more vehicles; a database storing a multi-layer representation of a geographical region and sensor data captured by sensors of the one or more vehicles; and a processor coupled to the database and communicable with the one or more vehicles through the communication interface, the processor configured to: receive, from a vehicle, a request to display the map for the geographical region around the vehicle, wherein the request identifies one or more layers of the map; retrieve, in response to the request, map data corresponding to the geographical region from the database; select the one or more layers from the multi-layer representation; display the map on a display installed in the vehicle based on the request.

10. The system of solution 9, wherein the multi-layer representation of the geographical region configures multiple layers based on a source of the map data such that a first layer corresponds to map data obtained from a first type of image sensor and a second layer corresponds to map data obtained from a second type of image sensor.

11. The system of solution 9, wherein the sensors include at least one of a camera, a Radio Detection And Ranging (RADAR) sensor, a Light Detection And Ranging (LIDAR) sensor, a Light Amplification by Stimulated Emission of Radiation (LASER) sensor, an ultrasound sensor, an infrared sensor, or any combination thereof.

12. The system of solution 9, further comprising: presenting, on the display of the vehicle, a list of selectable map features including one or more selectable map elements having map categories that correspond to at least one of lanes, road marks, boundaries, traffic lights, bounds, intersections, property types, or speed limits, wherein the map is displayed to include map data associated with a particular element category.

13. The system of solution 9, further comprising: comparing differences of the map data of the multi-layer representation of the geographical region; and visually presenting the differences on the map on the display of the vehicle.

14. A computer-readable storage medium having code stored thereon, the code, upon execution by one or more processors, causing the one or more processors to implement a method comprising: receiving, from to a user device associated with a user, a request to display a map for a geographical region around a vehicle; retrieving, in response to the request, map data having different file formats and configured in one or more layers; sending, to the user device, a list of selectable map features that include at least one of one or more selectable layers or one or more selectable map elements having element categories that correspond to lanes, road marks, boundaries, traffic lights, bounds, intersections, property types, or speed limits; receiving, from the user device, a selection of at least one map feature in the list of selectable map features; and displaying the map on a display of the user device based on the selection of the at least one map feature.

15. The computer-readable storage medium of solution 14, wherein the selection of the at least one map feature identifies a target layer to be displayed among the one or more layers.

16. The computer-readable storage medium of solution 14, wherein the selection of the at least one map feature identifies a particular element category among the lanes, the road marks, the boundaries, the traffic lights, the bounds, the intersections, the property types, or the speed limits.

17. The computer-readable storage medium of solution 16, wherein, upon the selection of the at least one map feature, the map data is displayed on the map with signal information that applies to the lanes such that the signal information corresponding to different lanes is distinguished from each other.

18. The computer-readable storage medium of solution 14, wherein the map data is configured in the one or more layers based on a source of the map data such that the one or more layers are associated with different types of image sensors, respectively.

19. The computer-readable storage medium of solution 18, wherein, upon the selection of the at least one map feature, the map is rendered to display map data from a particular type of image sensor without displaying map data from other types of image sensors than the particular type.

20. The computer-readable storage medium of solution 14, wherein the method further comprises: comparing differences among the one or more layers; and visually presenting the differences on the map displayed on the display of the user device.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. In some implementations, however, a computer may not need such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method of displaying a map, comprising:
receiving, from a user device, a request to display the map for a geographical region around a vehicle, wherein the request identifies layers the map including a first layer corresponding to map data obtained from a first type of image sensor and a second layer corresponds to map data obtained from a second, different, type of image sensor;
retrieving, in response to the request, map data corresponding to the geographical region from a map database that stores a multi-layer representation of the geographical region;
selecting, in response to the request, the layers from the multi-layer representation; and
displaying the map on a display of the user device based on the request.

2. The method of claim 1, wherein the first type of image sensor is a camera and the second type of image sensor is a lidar.

3. The method of claim 1, wherein the map data includes map elements that are associated with element categories, each map element categorized as one of lanes, road marks, boundaries, traffic lights, bounds, intersections, property types, and speed limits.

4. The method of claim 3, further comprising:
presenting, to the user device, a list of map elements included in the map,
upon a selection by the user of a particular map element having a particular element category, updating the map to display map elements corresponding to the particular element category.

5. The method of claim 4, wherein the particular map element corresponds to a particular lane and the map is updated to map data including road marks, traffic lights, and speed limits that are applied to the particular lane.

6. The method of claim 3, further comprising:
presenting, to the user device, a list of map elements included in the map,
upon a selection by the user of a particular map element having a particular element category, updating the map to remove map elements corresponding to element categories different from the particular element category.

7. The method of claim 1, further comprising:
comparing differences of the map data among one or more layers of the multi-layer representation of the geographical region; and
visually presenting the differences on the map displayed on the display of the user device.

8. The method of claim 1, wherein the map database includes at least two map data having different file formats from each other.

9. A system of displaying a map for a user, comprising:
a communication interface configured to communicate with one or more vehicles;
a database storing a multi-layer representation of a geographical region and sensor data captured by sensors of the one or more vehicles; and
a processor coupled to the database and communicable with the one or more vehicles through the communication interface, the processor configured to:
receive, from a vehicle, a request to display the map for the geographical region around the vehicle, wherein the request identifies layers of the map including a first layer corresponding to map data obtained from a first type of image sensor and a second layer corresponds to map data obtained from a second, different, type of image sensor;
retrieve, in response to the request, map data corresponding to the geographical region from the database;
select the layers from the multi-layer representation;
display the map on a display installed in the vehicle based on the request.

10. The system of claim 9, wherein the first type of image sensor is a camera and the second type of image sensor is a lidar.

11. The system of claim 9, wherein the sensors include at least one of a camera, a Radio Detection And Ranging (RADAR) sensor, a Light Detection And Ranging (LIDAR) sensor, a Light Amplification by Stimulated Emission of Radiation (LASER) sensor, an ultrasound sensor, an infrared sensor, or any combination thereof.

12. The system of claim 9, further comprising:
presenting, on the display of the vehicle, a list of selectable map features including one or more selectable map elements having map categories that correspond to at least one of lanes, road marks, boundaries, traffic lights, bounds, intersections, property types, or speed limits,
wherein the map is displayed to include map data associated with a particular element category.

13. The system of claim 9, further comprising:
comparing differences of the map data of the multi-layer representation of the geographical region; and
visually presenting the differences on the map on the display of the vehicle.

14. A computer-readable storage medium having code stored thereon, the code, upon execution by one or more processors, causing the one or more processors to implement a method comprising:
receiving, from to a user device associated with a user, a request to display a map for a geographical region around a vehicle;
retrieving, in response to the request, map data having different file formats and configured in layers including a first layer corresponding to map data obtained from a first type of image sensor and a second layer corresponds to map data obtained from a second, different, type of image sensor;
sending, to the user device, a list of selectable map features that include at least one of one or more selectable layers or one or more selectable map elements having element categories that correspond to lanes, road marks, boundaries, traffic lights, bounds, intersections, property types, or speed limits;
receiving, from the user device, a selection of at least one map feature in the list of selectable map features; and
displaying the map on a display of the user device based on the selection of the at least one map feature.

15. The computer-readable storage medium of claim 14, wherein the selection of the at least one map feature identifies a target layer to be displayed from the layers.

16. The computer-readable storage medium of claim 14, wherein the selection of the at least one map feature identifies a particular element category among the lanes, the road marks, the boundaries, the traffic lights, the bounds, the intersections, the property types, or the speed limits.

17. The computer-readable storage medium of claim 16, wherein, upon the selection of the at least one map feature, the map data is displayed on the map with signal information that applies to the lanes such that the signal information corresponding to different lanes is distinguished from each other.

18. The computer-readable storage medium of claim 14, wherein the map data is configured in the layers based on a source of the map data such that the each of the layers are associated with different types of image sensors.

19. The computer-readable storage medium of claim 18, wherein, upon the selection of the at least one map feature, the map is rendered to display map data from a particular type of image sensor without displaying map data from other types of image sensors than the particular type.

20. The computer-readable storage medium of claim 14, wherein the method further comprises:
comparing differences among the layers; and
visually presenting the differences on the map displayed on the display of the user device.
